(19) United States
(12) Patent Application Publication
(10) Pub. No.: US 2015/0091207 A1
(43) Pub. Date: Apr. 2, 2015

(54) Center insulated concrete form

(71) Applicant: John Milner McCary, SR., Birmingham, AL (US)

(72) Inventor: John Milner McCary, SR., Birmingham, AL (US)

(21) Appl. No.: 13/998,094

(22) Filed: Oct. 1, 2013

(51) Int. Cl. B29D 99/00

(52) U.S. Cl. CPC B29D 99/0021
USPC 264/273

(57) ABSTRACT

The invention is the manufactured assembly and process of using the concrete/cementous material flow through lattice panels to form and pour a center insulated concrete/cementous material poured wall. The center insulating solid panel, such as rigid insulation foam, is attached on both faces of the insulating solid panel to the flow through lattice panels by connecting cross members, or webs, keeping the concrete flow through lattice panels kept spaced apart and connected parallel to the solid insulation panel. Stencils, form liners or other shaping or decorative material can be attached to the exterior faces of the flow through lattice panels before pouring. Facial and/or decorative treatment can be performed on the wet, nearly dry or hardened lattice panel flow through concrete/cementous material.

### CROSS-REFERENCED TO RELATED APPLICATIONS

This application makes reference to U.S. Pat. No. 8,153,046 dated Apr. 10, 2012 and U.S. application Ser. No. 13/358,676 filed Mar. 1, 2012.

### BACKGROUND OF THE INVENTION

There have been recent advances and the need for poured concrete walls that have insulation as part of the concrete form assembly such as insulated concrete forms (I C F's) and rigid foam insulation being placed within wooden and metal concrete forms. In U.S. Pat. No. 8,153,046 and demonstrating further improvements in U.S. application Ser. No. 13/358,676 a poured concrete form is assembled and poured using flow through lattice panels connected to solid panels by connecting members. The solid panel could be an insulating panel, such as rigid foam insulation.

The higher cost of energy and new building codes have steadily pushed the poured concrete building industry to look for better ways to insulated structures. In many segments of the poured concrete structure industry there is the need to provide the durability of concrete on both faces of the poured concrete wall. Also there is the increased demand to provide a decorative appearance to the poured concrete exterior face(s). Decorative and finish treatment on the face of the poured concrete can give increased value and attractive looks to a structure. Time and expenses can be saved in decorative treatment of concrete walls when these activities can be performed at the same time, or near the same time, as pouring.

Tilt-up, some precast and cast-in-place poured concrete walls have made recent improvements in center wall insulation where concrete is formed on both sides of the rigid foam insulation. In tilt-up wall construction walls are poured as a horizontal concrete slab, cured and then a crane is used to place the panel in place. In most pours the exterior face of the panel is poured first, face down. Tilt-up surface finishes include single and multi-use form liners, placed on the pouring surface or “bed” before the panel is poured, creating various patterns and textures to the concrete surface. Also there are many color variations of stains and epoxy paints that can be applied to the exposed facial concrete surface(s).

In the center insulated tilt-up pouring process the face or first concrete layer is poured and smoothed. Sheets of foam insulation are then placed on the first concrete layer before the first layer dries. Concrete ties are placed through the foam insulation sheets extending down into the first concrete layer. The concrete/foam ties also extend up a certain height above the foam sheeting. The ties are used to unitize the first concrete layer and the next poured top concrete layer. After the two concrete layers adequately dry and harden, which usually takes about seven days, the poured panels may be lifted or tilted up into place.

The speed to erect insulated walls and to provide decorative facial finished in tilt-up construction can enable tilt-up to be competitive in larger “Big Box’ style structures such as lager stores, warehouses or distribution centers. The cost to crane lift the tilt-up slab wall in place is expensive and the architectural style and look of tilt-up structures is fairly limited due to the nearly flat repeated slab panel construction. Also tilt-up construction consists of panels being poured individually and then tilted up and attached end to end to each other resulting in a non-continuous concrete pour, the concrete total wall pour being non-monolithic.

### SUMMARY OF THE INVENTION

The invention is the manufactured assembly and process of using the concrete/cementous material flow through lattice panels to form and pour a center insulated concrete/cementous material poured wall. The center insulating solid panel, such as rigid insulation foam, is attached on both faces of the insulating solid panel to the flow through lattice panels by connecting cross members, or webs, keeping the concrete flow through lattice panels kept spaced apart and connected parallel to the solid insulation panel. Stencils or other surface material, such as “poly” sheeting, plywood and form liners, may be placed on the external surface of the lattice panels before pouring concrete. Concrete is poured into the two cavities, created by the connecting webs attached to the solid insulation pane and lattice panels, flowing through the openings in the lattice grid panels and extends beyond the external surface of the lattice panel. Troweling, smoothing, removing stencils, form liners, “poly sheeting”, and/or performing decorative on the flowable concrete that extends beyond the external surface of one and/or both lattice panels. The poured concrete then is hardened dry. The attaching mechanism within and on the face of the solid insulation panel and the connecting webs help unitize the two poured concrete cavities.

The solid insulating panel has projections that fit into receiving recesses on the top and bottom edges, and also on the end edges, so like panels can interconnect with each other. Many of the top and bottom edge projections are “U” shaped compression slotted being slightly tapered on the top edges of the projections. The “U” shaped projections are also slightly wider in circumference than the receiving recesses. When the “U” shaped compression slotted projections are placed into the receiving recesses the “U” shaped projections compress into the slotted space to fit fairly tightly into the receiving recess. Since there would not be any bracing to hold the solid insulation panels together during a pour the tightly fitting “U” shaped projections help to hold the solid insulating panels together and assisting to not lift up during a pour. To assist the installer when assembling and placing the solid insulating panel and the assembled center insulated form, the connection web attaching points on the face of the solid insulating panel and the panel's projections and recesses are so arranged that the solid insulating panels can be interconnected with a like panel in a bi-directional or reversible fashion. The flow through lattice panels can be interconnected to like panels in a bi-directional manner.

Both wall form cavities can be poured at the same pouring or one cavity side of the solid insulation panel can be poured. Any bracing can then be removed from the non-poured cavity side after the first poured concrete has adequately hardened and the remaining cavity poured. The structure interior facing cavity, or inside cavity, of the center insulating panel concrete form is usually wider than the exterior cavity and the interior cavity when poured is usually load bearing though both poured cavities together add tension and compression strength to the wall.

Structures built with the invention are not limited in architectural design as panelized built structures. Most any architectural design can be built with the invention form and be very cost competitive to other center insulated concrete forming methods. Also the structures built with the inventions center insulated poured forms are monolithically unitized.

One advantage of being able to pour the wall form cavities at separate pours when using the center insulated wall concrete form is that bracing can be put on the face side of the wall that is not to be poured. Then the wall bracing can be removed and the other cavity of the lattice wall form can be poured without the need for bracing since the first cavity poured and set gives enough strength to keep the wall straight in the second pouring. Also there is no bracing to get in the way of finishing the flow through exterior surface of the second pour.

### BRIEF DESCRIPTION OF THE INVENTION

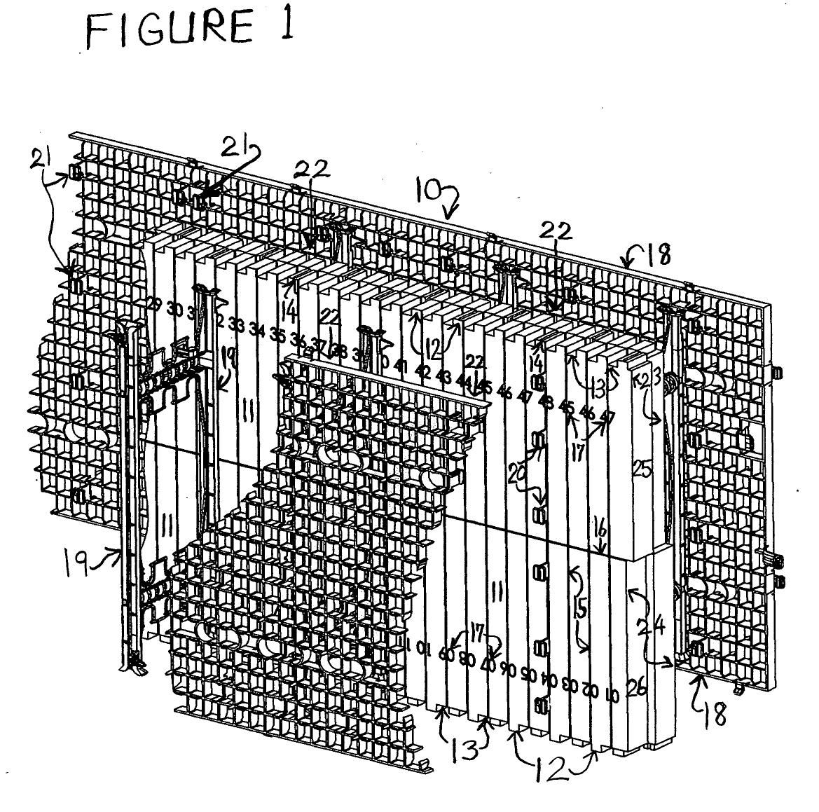

FIG. 1 shows in a front perspective view the center insulated concrete form with center placed solid insulation panel, connecting webs and attached flow through lattice panels.

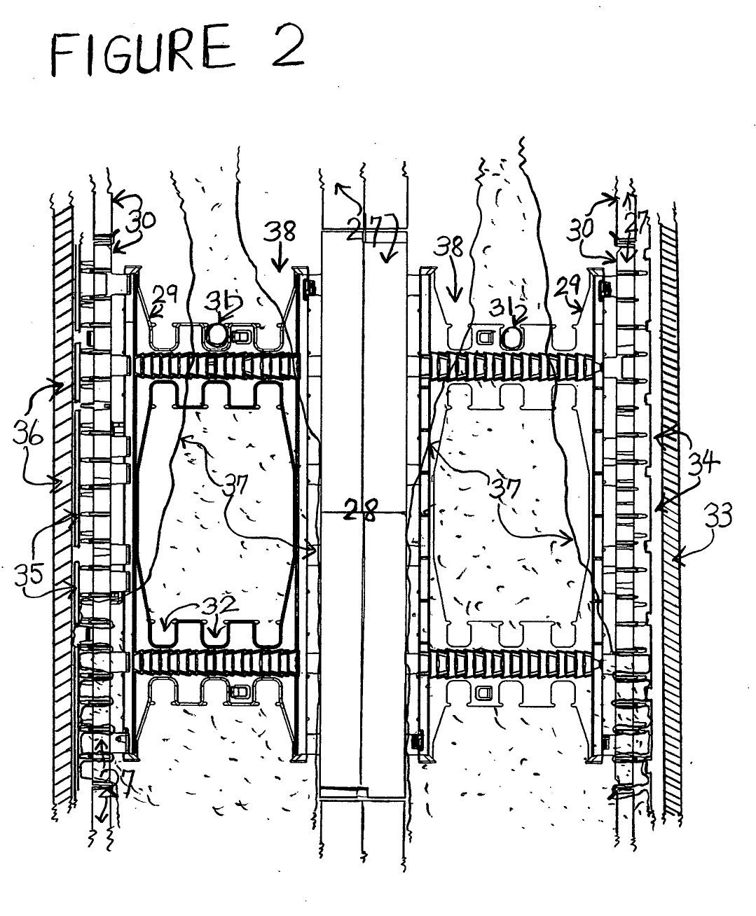

Shown in a side cross-sectional view, in FIG. 2, are stacked paneled center insulated concrete forms with a brick shaped plywood backed urethane form liner attached to the exterior face of the attached flow through lattice panels and a stencil and form liner attached to the exterior face of the opposing side flow through lattice panels, with concrete/cementous material being poured into the center insulated form cavities.

### DETAILED DESCRIPTION OF THE PREFERRED EMBODIMENTS

Shown in FIG. 1, in a front perspective view, is the center insulated concrete form 10. Shown is the solid insulation panel 11 with top and bottom edge attaching projections 12 and recesses 13. The compression slot projections 14 are shown. Vertical 15 and horizontal 16 marked line(s) are shown along with vertical line location numbers 17 on the solid insulation panel. The concrete flow through lattice panels 18 are shown attached to the connection web members 19 by the attaching points 20 on the face of the solid insulation panel and connecting webs attached to the lattice panels at attaching points 21. Two cavities 22 are formed between the solid insulating panel and the two lattice panels 18. The panel end upper row section 23 and the lower row section 24 are shown along with their projections 25 and recesses 26.

FIG. 2 shows in a side cross-sectional view a stacked panel center insulated concrete form 27 with the solid center insulation panels 28, the web connecters 29, attached flow through lattice panels 30 and rebar 31 placed in the rebar holders 32 of the web connecters 29. A plywood backed 33 brick shaped form liner 34 is attached to the exterior face of one of the flow through lattice panels. A stencil 35 and form liner 36 is attached to the exterior face of the other flow through lattice panel. Concrete/cementous material 37 is shown being poured into the two center insulated concrete form cavities 38.

1. A manufactured assembly and method where concrete/cementous material flow through lattice panels are used in forming a center insulated poured concrete wall, comprising the steps of:
a) assembling a plurality of poured concrete wall forming modular units, wherein each modular unit consists of a first lattice framework panel having a plurality of openings there through, a center located rigid foam insulation panel, a second lattice framework panel and a plurality of connecting members that can secure said first panel to one side of the rigid foam insulation panel, and a plurality of connecting members that can secure said second lattice framework panel to the other side of the rigid foam insulation panel, in a spaced, parallel relationship such that a cavity is formed between said first panel and the rigid foam insulation panel and a second cavity formed between the said rigid foam insulation panel and the second lattice panel, for receiving flowable concrete/cementous material mixture therein;
b) stacking the assembly of solid insulation panel with attached lattice panels one assembly atop another center insulated concrete form assembly and also placing the center insulated concrete form assemblies end to end, as needed;
c) placing/attaching any stencils or other concrete/cementous material surface treatment material, such as form liners, plywood or “poly” sheeting, on the exterior face of the lattice panel(s) as needed;
d) introducing said flowable concrete into said cavities, not necessarily at the same pouring time, wherein when said flowable concrete is poured such that the flowable concrete fills the cavity poured, concrete flowing non-restrictively through and around the connecting members, and extends through said openings through the lattice framework panel such that said flowable concrete extends beyond an external surface of the cavity(s) lattice panel;
e) possibly troweling or smoothing and/or performing any decorative treatment on said flowable concrete that extends beyond said external surface of said first and the second lattice panel, and/or removing stencils or other lattice panel concrete flow through surface treatment material, such as form liners, plywood or “poly” sheeting, as needed;
f) allowing said flowable concrete to set, wherein said first and second panel, connecting members and said flowable concrete/cementous material mixture become a substantially monolithic structure when said flowable/cementous mixture is set and hardens dry;
g) removing lattice panel concrete flow through surface treatment material, such as stencils, form liners, plywood or “poly” sheeting, as needed.

2. A manufactured assembly and method where concrete/cementous material flow through lattice panels are used in forming a center insulated poured concrete wall according to claim 1, further the solid insulation panel having top and bottom edges and interconnecting means on said top and bottom edges, comprising:
a) wherein the interconnecting means comprise at least two rows of alternating projections and recesses, and;
b) various placed projections, but not all, are “u” shaped with compression slot spaces formed into the slightly tapered top sections plus having a slightly larger body size than recesses, giving the compression slotted “U” shaped projections a different shape that the other non-compression slotted projections, and;
c) when the compression slotted “U” shaped projections, are placed into the receiving recesses the compression slot space allows the slightly larger projection to compress inward and fit tightly into the receiving recess, helping to hold the solid insulation panels together and not lift apart during a pour, and;
d) wherein said recess of one row is adjacent said projection of the other row, and
e) wherein said interconnecting means on said top and bottom edges are offset arranged such that said recess of one row on said top edge is opposed to said projection of an opposite row of said bottom edge, and;
f) whereby the solid insulation panel can be interconnected with a like solid insulation panel in a bi-directional or reversible manner.

3. A manufactured assembly and method where concrete/cementous material flow through lattice panels are used in forming a center insulated poured concrete wall according to claim 1, further the solid insulation panel having interconnecting means on the ends of the panel, comprising:
a) wherein the interconnecting means comprise at each end of the solid insulation panel an upper row section, made up of at least two rows, and a lower row section, made up of at least two rows, each row of the upper and lower row sections consist of alternating projections and recesses, and;
b) said projections and recesses being of substantially the same dimension, and;
c) wherein on each end of the solid insulation panel said recess of the upper row section is adjacent said projection of the lower row section, and;
d) wherein on each insulation panel end said projection of the upper row section is adjacent said recess of the lower row section, and;
e) wherein said interconnecting means of said each end of the insulation panel are offset arranged such that said recess of one row on each end of the panel is opposed to said projection of an opposite row of said other opposing end of the panel, and;
f) whereby said insulating solid panel can be interconnected end to end with like insulating solid panel in a bi-directional or reversible manner, and;
g) wherein the projections fitting into the recesses of end to end like insulating panels helps to hold the interconnected panels from lifting up during a pour.

4. A manufactured assembly and method where concrete/cementous material flow through lattice panels are used in forming a center insulated poured concrete wall according to claim 1, whereby the solid insulating panel is marked on both sides of the exterior faces with vertical and horizontal lines to assist the installer when cutting the center insulating panel to the desired size.

5. The center insulating panel according to claim 4, wherein the vertical marked lines are spaced apart at one inch intervals.

6. The center insulating panel according to claim 5, wherein the vertical marked lines are numbered.
